(19) United States
(12) Patent Application Publication
(10) Pub. No.: US 2026/0185902 A1
(43) Pub. Date: Jul. 2, 2026

(54) DETONATION DETECTION

(71) Applicant: Caterpillar Inc., Peoria, IL (US)

(72) Inventors: Michael S. Marchionda, Washington, IL (US); Jason E. Preis, Peoria, IL (US); Chad F. Ahmad, Peoria, IL (US)

(73) Assignee: Caterpillar Inc., Peoria, IL (US)

(21) Appl. No.: 19/003,132

(22) Filed: Dec. 27, 2024

(51) Int. Cl. G01M 15/11; G01M 15/05; G01M 15/12

(52) U.S. Cl. CPC G01M 15/11; G01M 15/05; G01M 15/12

(57) ABSTRACT

A system for identifying detonation within a cylinder of an engine may include a vibration sensor arranged on an engine block, a temperature sensor arranged at an exhaust port of a cylinder, and a computing device in data communication with the vibration sensor and the temperature sensor. The computing device may be adapted for receiving the vibration signal, receiving the temperature signal, periodically or continually comparing the vibration signal to a vibration threshold, periodically or continually comparing the temperature signal to a temperature threshold, if vibration signal exceed the vibration threshold and the temperature signal exceeds the temperature threshold, monitoring an elapsed time that both the vibration signal and the temperature signal exceed their respective thresholds; and if the elapsed time exceeds a threshold anomaly time, identifying a detonation event.

### DESCRIPTION

### TECHNICAL FIELD

The present application relates generally to engine monitoring. More particularly, the present application relates to monitoring combustion of natural gas engines and/or dual fuel engines. Still more particularly, the present application relates to monitoring natural gas and/or dual fuel engines for detonation.

### BACKGROUND

Engines that use natural gas for fuel such as natural gas engines or dual fuel engines, which use both natural gas and diesel fuel, may be subject to instances or periods of detonation. Detonation involves a mode of natural gas combustion where the air/fuel charge burns rapidly, which can generate a high amplitude pressure wave within the engine cylinder. This can cause the cylinder pressure to oscillate. In some cases, this can exceed engine operations parameters such as cylinder pressure limits, force limits on the engine head, and other hardware limits.

Chinese patent 113586240 relates to an engine knock detection method. When a knock sensor detects a knock signal for the first time, the exhaust temperature of the engine at the moment is detected and recorded as the first temperature; and whether the first temperature is greater than a temperature limit value is judged, and if yes, the engine knocks. Chinese patent 114961990 relates to an engine preignition monitoring method and system.

### SUMMARY

In one or more examples, a system for identifying detonation within one or more of a plurality of cylinders in an engine may be provided. The system may include a plurality of vibration sensors arranged on an engine block of the engine and configured to generate vibration signals associated with each of the plurality of cylinders. The system may also include a plurality of temperature sensors each arranged at respective exhaust ports of the plurality of cylinders and configured to generate temperature signals of the exhaust gas temperature associated with each of the plurality of cylinders. The system may also include a computing device in data communication with the plurality of vibration sensors and the plurality of temperature sensors. The computing device may include a processor and a computer readable storage medium having computer implemented instructions stored thereon and performable by the processor. The instructions may be adapted for receiving a plurality of vibration signals, each being from one of the plurality of vibration sensors, receiving a plurality of temperature signals, each being from one of the plurality of temperature sensors, generating a plurality of filtered vibration signals each corresponding to one of the plurality of vibration signals, and generating a plurality of filtered temperature signals each corresponding to one of the plurality of temperature signals. The instructions may also be adapted for periodically or continually comparing each of the filtered vibration signals to a vibration threshold and periodically or continually comparing each of the filtered temperature signals to a temperature threshold. The instructions may also provide for monitoring if any of the filtered vibration signals associated with one of the plurality of cylinders exceed the vibration threshold and a filtered temperature signal associated with the one of the plurality of cylinders exceeds the temperature threshold and monitoring an elapsed time that both the filtered vibration signal and the filtered temperature signal exceed their respective thresholds. The instructions may also provide for monitoring if the elapsed time exceeds a threshold anomaly time, then identifying a detonation event.

In one or more examples, a method of identifying detonation of an engine having a plurality of cylinders may include receiving a plurality of vibration signals each associated with one of the plurality of cylinders, receiving a plurality of temperature signals each associated with one of plurality of cylinders, generating a plurality of filtered vibration signals each corresponding to one of the plurality of vibration signals, and generating a plurality of filtered temperature signals each corresponding to one of the plurality of temperature signals. The method may also include periodically or continually comparing each of the filtered vibration signals to a vibration threshold and periodically or continually comparing each of the filtered temperature signals to a temperature threshold. The method may also provide for monitoring if any of the filtered vibration signals associated with one of the plurality of cylinders exceed the vibration threshold and a filtered temperature signal associated with the one of the plurality of cylinders exceeds the temperature threshold, and monitoring an elapsed time that both the filtered vibration signal and the filtered temperature signal exceed their respective thresholds. The method may also provide for monitoring if the elapsed time exceeds a threshold anomaly time and then identifying a detonation event.

In one or more examples, a system for identifying detonation within a cylinder of an engine may include a vibration sensor arranged on an engine block of the engine and configured to generate a vibration signal associated with the cylinder, a temperature sensor arranged at an exhaust port of the cylinder and configured to generate a temperature signal of the exhaust gas temperature associated with the cylinder, and a computing device in data communication with the vibration sensor and the temperature sensor. The computing device may include a processor and a computer readable storage medium having computer implemented instructions stored thereon and performable by the processor. The instructions may be adapted for receiving the vibration signal, receiving the temperature signal, periodically or continually comparing the vibration signal to a vibration threshold, and periodically or continually comparing the temperature signal to a temperature threshold. The instructions may also provide for monitoring if the vibration signal exceed the vibration threshold and the temperature signal exceeds the temperature threshold and monitoring an elapsed time that both the vibration signal and the temperature signal exceed their respective thresholds. The instructions may also provide for monitoring if the elapsed time exceeds a threshold anomaly time, identifying a detonation event.

### DESCRIPTION OF THE DRAWINGS

FIG. 1A is a perspective view of a combustion engine such as a dual fuel engine, according to one or more examples.

FIG. 1B is a cross-sectional view of the combustion portion thereof.

FIG. 2 is a schematic diagram of a communication system for use in monitoring, diagnosing, and/or managing the operation of the engine, according to one or more examples.

FIG. 3 is a flow diagram depicting a method of detonation detection, according to one or more examples.

FIGS. 4A-4D are diagrams depicting an approach of filtering a vibration signal, according to one or more examples, where:

FIG. 4A depicts a raw signal from a vibration sensors;

FIG. 4B depicts moving minimum thereof;

FIG. 4C depicts moving minimum from several cylinders of an engine and a median moving minimum; and

FIG. 4D depicts a difference between each cylinder moving minimum relative to the median.

FIGS. 5A-5D are diagrams depicting an approach of filtering a temperature signal, according to one or more examples, where:

FIG. 5A depicts a raw temperature signal from a temperature sensor;

FIG. 5B depicts an adjusted signal as the difference between the raw temperature data signals and a median temperature signal;

FIG. 5C depicts an exponentially waited moving average (EWMA) signal; and

FIG. 5D depicts a difference between the adjusted signal and the EWMA signal.

FIGS. 6A-6D are diagrams depicting a vibration signal and a temperature signal that each exceed respective thresholds for amounts of time sufficient to constitute a detonation event, according to one or more examples, where:

FIG. 6A includes revolutions per minute and a raw detonation signal;

FIG. 6B includes information similar to FIG. 6A, but later in time;

FIG. 6C includes raw temperature signals and a detonation counter for the time period of FIG. 6A; and

FIG. 6D includes raw temperature signals and a detonation counter for the time period of FIG. 6B, where the high detonation signal of FIG. 6B corresponds in time with the low temperature signal of FIG. 6D and, as such, the detonation counter is active.

FIG. 7A is a portion of a diagram depicting a summary of a detonation event, according to one or more examples.

FIG. 7B is another portion of the diagram depicting a summary of a detonation event, according to one or more examples.

### DETAILED DESCRIPTION

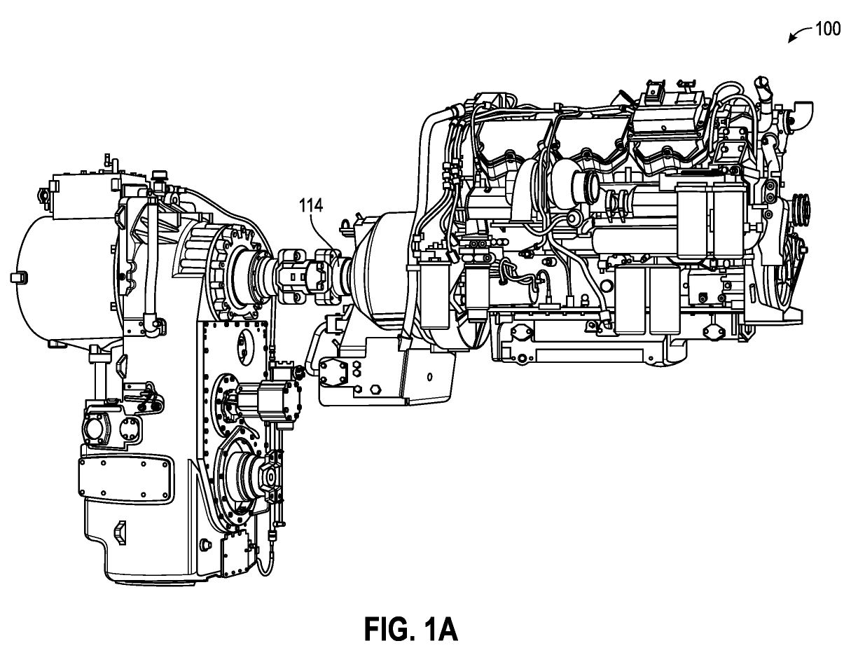

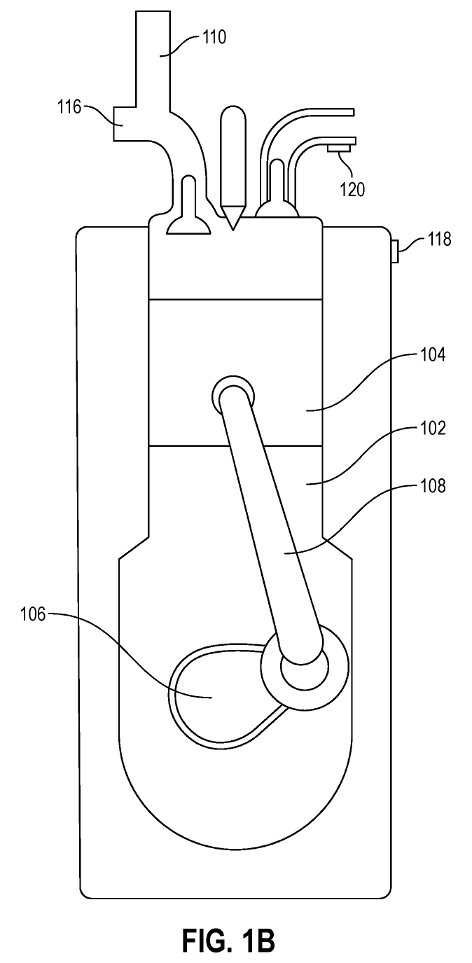

FIG. 1A is a perspective view of a combustion engine 100 such as a dual fuel engine or a natural gas engine. As shown in FIG. 1B, the combustion engine 100 may include one or more cylinders 102 with reciprocating pistons 104 arranged therein. The pistons 104 may be connected to a crank shaft 106 via one or more rods 108. The engine 100 may include a fuel manifold 110 that receives fuel from a fuel tank via a fuel pump, for example. The fuel manifold 110 may be arranged and configured to deliver fuel to the cylinders 102 via one or more fuel injectors 112. The engine 100 may also include an air system 116 that receives air from outside of the engine, delivers air to the cylinders 102 for combustion, treats the air, and exhausts the air back into the environment. The combustion engine 100 may also include an ignition system for delivering a spark to the cylinders 102 to burn the fuel/air mixture received from the fuel manifold 110 and the air system 116, which may drive the pistons 104 to turn the crank shaft 106 and generate rotational power. In one or more examples, the engine 100 may include a power takeoff or fly wheel 114 for coupling to equipment to be mechanically powered. In one or more examples, the equipment to be powered may include waterborne vessels, electrical generators, heavy equipment or work machines, or other systems.

As shown in FIG. 1B, various sensors may be provided to assist with monitoring, diagnosing, and/or managing the operation of the engine 100. In one or more examples, a sensor or set or plurality of vibration sensors 118 may be provided within or on the engine block. In one or more examples, the vibration sensor 118 may be arranged between cylinders. The vibration sensor 118 may include an acoustic sensor such as an accelerometer or a piezoelectric sensor adapted for sensing vibration of the engine block. In some examples, the vibration sensor may be referred to as a knock sensor. The sensor or sensors 118 may be arranged such that vibration from particular cylinders may be captured. For example, for a bank of three cylinders and two sensors arranged at the 1/3 points along the bank (i.e., between the 1^{st} and 2^{nd} cylinder and between the 2^{nd} and 3^{rd} cylinder), vibration sensed by the sensors may be determined to have been generated by a particular cylinder. That is, for example, the engine timing, the timing of the vibration, and the location of the sensors may be used to identify which cylinder the vibration came from. Still other arrangements of sensors 118 and approaches to identifying which cylinder generated the vibration may be provided. For example, the sensor or sensors may be located directly at each cylinder rather than between them. In this case, the engine timing may still be used to identify or confirm which cylinder is exhibiting/causing the vibration. Still other approaches may be used such as in-cylinder pressure sensors or other sensors adapted to identify and measure vibration from engine cylinders.

In addition to the vibration sensor 118, a temperature sensor or sensors 120 may also be provided. In one or more examples, a temperature sensor 120 may be provided at the exhaust port 122 of the cylinders 102 of the engine 100 and, in particular, may be provided at each exhaust port 122 of each cylinder 102 of the engine. The temperature sensors 120 may be one of several different types of available temperature sensors, including, for example, a thermocouple, a thermistor, a resistance temperature device, an infrared device, or other types of temperature sensors.

In one or more examples, a computing system 148 may be provided to monitor, diagnose, and/or operate the combustion engine 100. In particular, the computing system 148 may be in communication with the one or more sensors 118/120 arranged on, at, or within the engine 100 to capture data generated by the sensors 118/120. In one or more examples, the computing system 148 may include an electronic control module of a work machine or other equipment powered by the combustion engine 100. In some examples, the computing system 148 may be associated with, arranged on, or coupled to the combustion engine 100. In the case of an ECM or other computing device 148 in close proximity to the combustion engine 100, the computing device 148 may be in data communication with the sensors 118/120 via a wired connection or via close range wireless communications. In other cases, where the computing system 148 is remote from the combustion engine 100, the computing device 148 may be in wireless communication with the sensors 118/120 where the sensors 118/120 on the combustion engine 100 may include a transmitter or transceiver 150 for transmitting the sensed data and/or allowing for control of the sensors as well as receipt of data from the sensors.

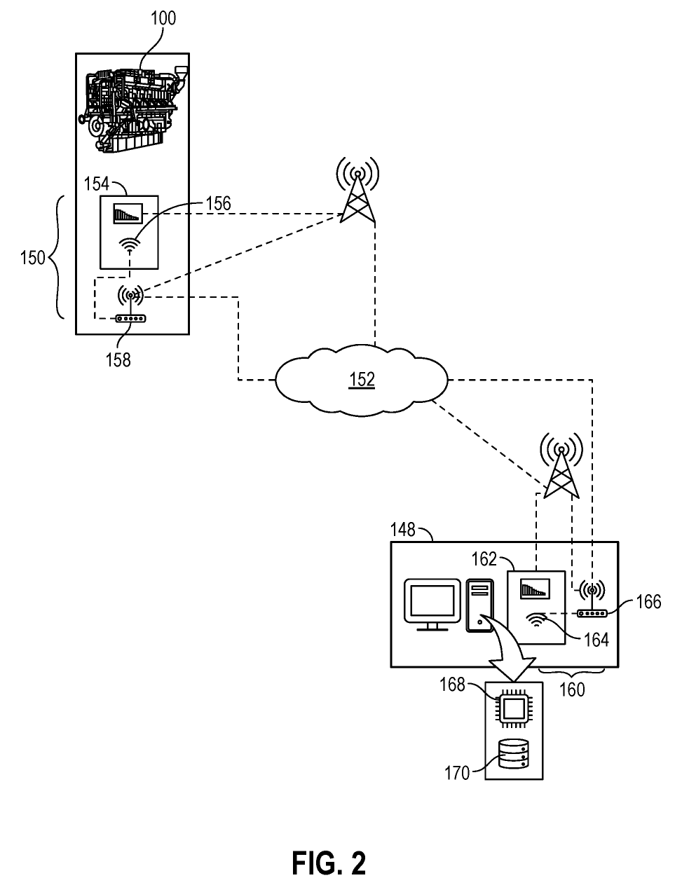

In the case of remote monitoring of the engine performance and with reference to FIG. 2, as mentioned, the combustion engine 100 may include a transmitter or transceiver 150. The transmitter or transceiver 150 may be in wireless communication with a wide area network 152. Such wireless communication may be direct from the transmitter/transceiver 150 such as a cellular connection 154 or via a WiFi connection 156 onboard the equipment or work machine being powered by the combustion engine 100. The WiFi connection 156 may provide for connection to a router 158, which may provide access to the wide area network 152. At the other end of the communication, the computing device 148 may include a receiver or a transceiver 160 so that it may receive data from the sensors 118/120 of the combustion engine 100 and/or send control and/or operating signals to the combustion engine 100. Like the combustion engine 100, the computing device 148 may be in communication with the wide area network 152 directly such as via a cellular connection 162, or via a WiFi connection/router 164/166 that may provide access to the wide area network 152. It is to be appreciated that while WiFi has been mentioned, other local area network communication protocols may also be provided. Similarly, while cellular has been mentioned, still other wide area network communication protocols may also be used. For example, satellite transmission or other long distance communications system may be provided.

The computing device 148 may include one or more inputs, one or more outputs, a processor 168, and a computer readable storage medium 170. In some cases, the one or more inputs may include a keyboard and/or mouse as well as the receiver that receives data from the sensors on the combustion engine directly (e.g., wired) or wirelessly. The computing device 148 may include computer implemented instructions stored within the computer readable storage medium 170. The computer implemented instructions may take the form of hardware, software, or a combination of hardware and software. That is, in one or more examples, the instructions may be in the form of microchips or other hardware components particularly suited for particular tasks and may form a part of the computer readable storage medium 170. In other examples, software may be provided and stored in the computer readable storage medium 170. In still other examples, a combination of the two may be provided.

### INDUSTRIAL APPLICABILITY

The computer implemented instructions may be particularly suited for monitoring, diagnosing, and/or managing the operation of the combustion engine 100 and/or the associated work machine or equipment. The computer implemented instructions may be accessible by the processor 168 to perform one or more operations defined by the instructions. In one or more examples, the computer implemented instructions may be particularly adapted for identifying detonation events and for adjusting operation of the engine 100 to reduce or eliminate the detonation event or events.

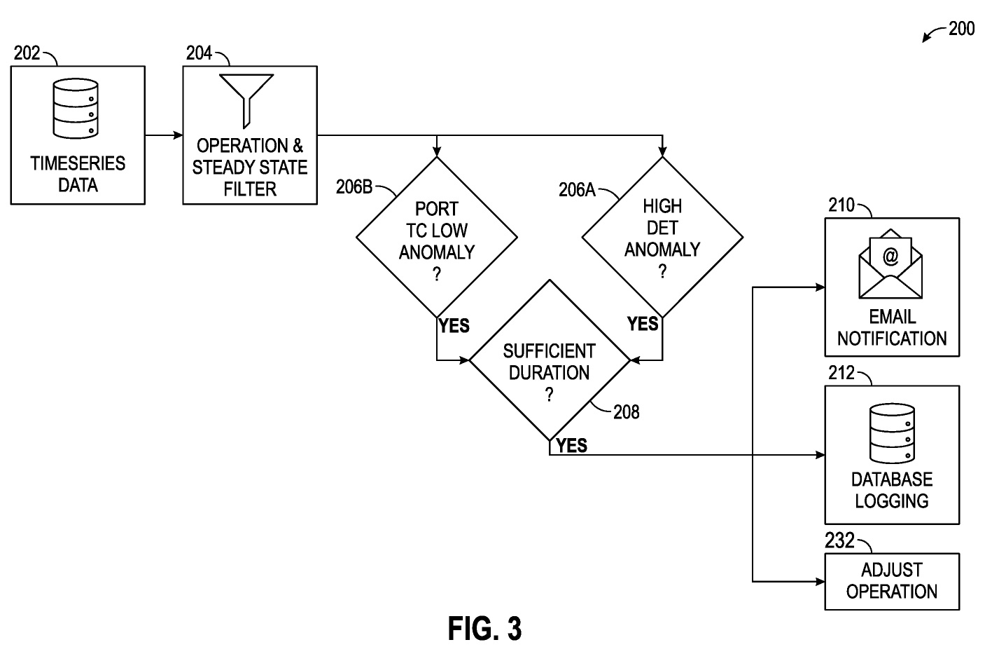

For example, as shown in FIG. 3, a diagram of a process 200 for identifying and reducing detonation is provided and the computer implemented instructions for performing the process 200 may be stored on the computer readable storage medium. As shown, the instructions may include processes for receiving 202 sensor data. For example, signals from the vibration sensors 118 and the temperature sensors 120 may be received by the computing device 148 on an ongoing basis or for selected periods of time. In one or more examples, sensor data may be captured only when the engine is running above 900 revolutions per minute (RPM). Still further, the data may be captured only when some level of natural gas fuel is being supplied to the engine 100. In other cases, data may be captured continuously, but data captured during these conditions (e.g., below 900 RPM or when no natural gas fuel is being supplied) may be discarded or ignored. In still other examples, data captured during these conditions may be used or used for other purposes.

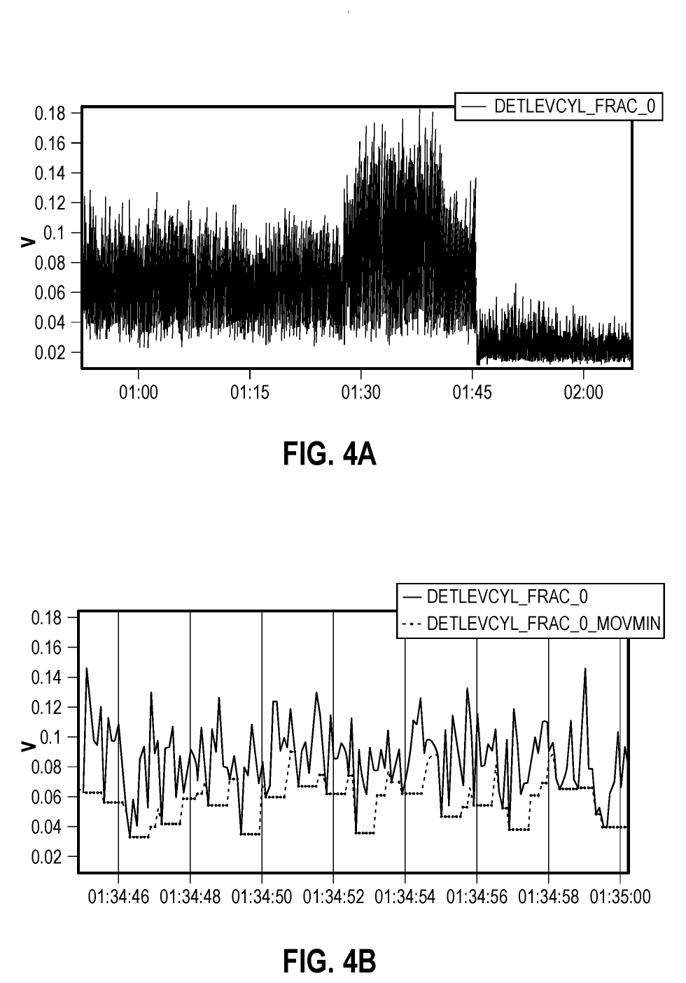

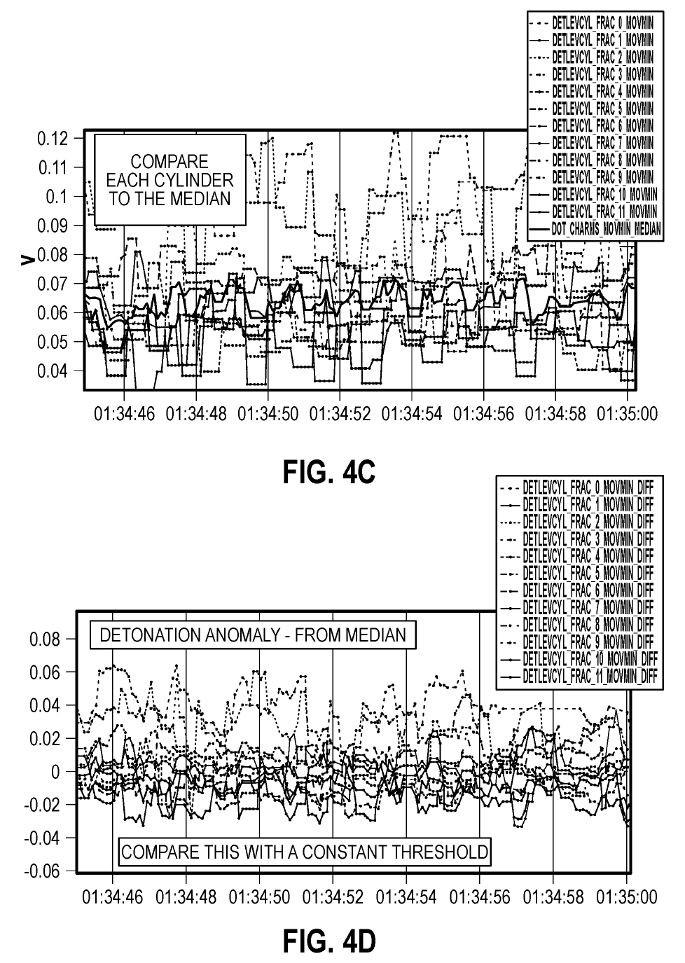

The method 200 may also include filtering 204 the data to make it more suitable for use and analysis. For example, with reference to FIGS. 4A-4D, the raw vibration sensor data may appear as a voltage signal similar to that shown in FIG. 4A. In one or more examples, the method may include filtering the raw signal using a 0.5 second moving minimum to arrive at a voltage signal similar to that shown in FIG. 4B. This may simplify the signal and may also reduce the risk of false positives which overestimate the occurrences of detonation and can lead to unnecessary or excessive equipment controls or interruptions. It is to be appreciated that other time intervals other than 0.5 seconds may be used, such as 0.1 seconds, 0.2 seconds, 0.3 seconds, 0.4 seconds, 0.6 seconds, 0.7 seconds, 0.8 seconds, 0.9 seconds, 1.0 seconds, 1.5 seconds, 2.0 seconds, and other time intervals. Based on the adjusted signals from all of the cylinders in the engine, a median signal may be calculated as shown in FIG. 4C. The median signal may be useful by being close to the middle of the range of the signals excluding outliers. Since the goal of the analysis is to identify outliers, the median may be a better signal to measure against than, for example, a mean signal. For purposes of comparison, a signal depicting the difference of each cylinder’s vibration signal from the median signal may also be calculated as shown in FIG. 4D. This delta vibration signal (e.g., of the difference of each moving minimum adjusted signal from the median) may be compared to a constant threshold. That is, a vibration anomaly or abnormally high vibration signal for any given cylinder may be identified when that cylinder’s vibration varies from the median of all of the cylinder vibrations by a threshold amount or more than the threshold amount. In one or more examples, the constant threshold may range from approximately 0.05 to approximately 0.5 volts or from approximately 0.075 to approximately 0.3 volts or a threshold of approximately 0.1 volts may be used. The filtered vibration threshold may be said to exceed the threshold when the difference between the vibration signal (adjusted for a moving minimum) is above the median by the thresholds mentioned. While “exceeds” in this case reflects going above a threshold value, “exceeds” should be construed to mean “goes beyond” rather goes above or higher. For example, as discussed in more detail below with respect to temperature, going below a low-level threshold may be said to “exceed” the threshold as well.

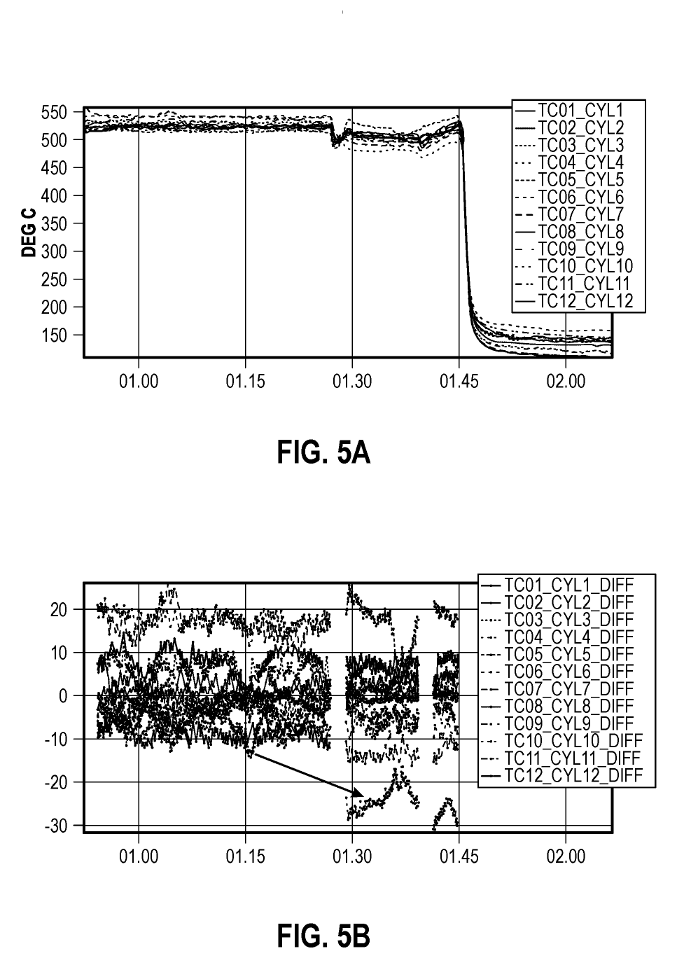

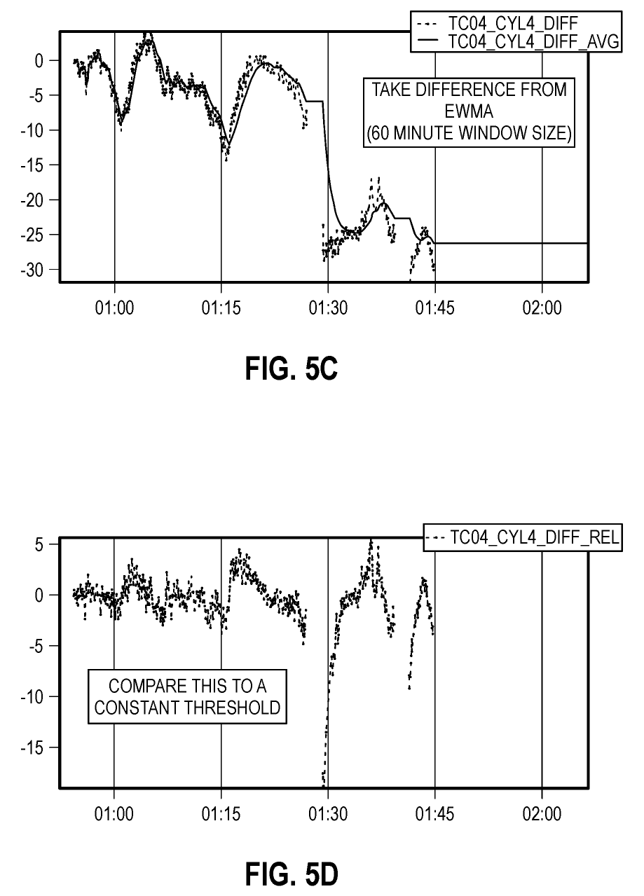

The temperature data signals may be filtered 204 as well. For example, the raw temperature data signals may be provided as shown in FIG. 5A. A median of all of the temperature signals may be calculated and subtracted from the several temperature signals to arrive at delta or adjusted temperature signal as shown in FIG. 5B. However, unlike the vibration signal, the difference of the temperature values from the median may be less indicative of a problem than a change in the temperature of any given cylinder because some cylinders may generally run warm or cold by nature. In view of this, an exponentially weighted moving average (EWMA) using a 60-minute window size may be used (FIG. 5C) and the difference between each adjusted signal from the EWMA signal may be calculated (FIG. 5D) and compared to a constant threshold. It is to be appreciate that different time interval may be used for the window size of the EWMA such as 30 minutes, 45 minutes, 75 minutes, 90 minutes, 120 minutes, and other time intervals. In this case, the constant threshold may include temperature drops ranging from approximately 10 °C to approximately 40 °C or from approximately 20 °C to approximately 30 °C, or a temperature drop of 25 °C may be used. The filtered temperature signal may be said to exceed the threshold when the difference falls below the mentioned threshold. That is to say that “exceeds” should be construed to mean “goes beyond” rather than goes above or higher. Here, since the threshold is a negative number (e.g., a temperature drop of 25 °C would be reflected by a calculated value of - 25 °C), exceeding the threshold would include temperature drops that are more negative than the threshold (e.g., -30 °C or -40 °C) and, as such, are higher in magnitude than the threshold, but lower in value.

The method 200 may also include monitoring 206A the filtered vibration signal of the several cylinders of the engine. As suggested, the monitoring may include comparing the filtered vibration signal to a constant threshold. Where the filtered vibration signal is abnormally high, the system may identify and track this condition. The high vibration may be indicative of a detonation event because the nature of detonation is to emit a large amplitude pressure wave into the cylinder causing the cylinder pressure to oscillate.

The method may also include monitoring 206B the filtered temperature signal of the several cylinders of the engine. As suggested, the monitoring may include comparing the filtered temperature signal to a constant threshold. Where the temperature of a given cylinder is abnormally low, the system may identify and track this condition. The low temperature of the exhaust port of the cylinder may be indicative of a detonation event because the rapid combustion causes the heat that is released from the air/fuel charge to be disseminated earlier in the power and exhaust strokes, so the temperature of the exhaust gas leaving the cylinder may be lower than during normal (e.g., non-detonation) operation.

The system may keep track of how long either and/or both of the above-mentioned conditions (e.g., low temp. and excessive vibration) are occurring and determine 208 if an anomaly is occurring for a sufficiently long period of time. That is, the system may continually monitor the exhaust temperature at each port and the vibration of each cylinder and may continually filter each signal as outlined for each of these parameters. When the exhaust port temperature is abnormally low or when the vibration is abnormally high, or both, the system may establish an elapsed time for each parameter. When the elapsed time meets or exceeds a defined threshold, the abnormal operation may be deemed sufficiently long to constitute a detonation event or a detonation event that should be addressed. In one or more examples, the method may require that the threshold for both the exhaust port temperature and the vibration be met or exceeded and may also require that both thresholds be met or exceeded for a particular amount of time. In one or more examples, the amount of time may range from 1 second to 10 seconds, or the amount of time may range from 3 seconds to 7 seconds, or the amount of time may be approximately 5 seconds.

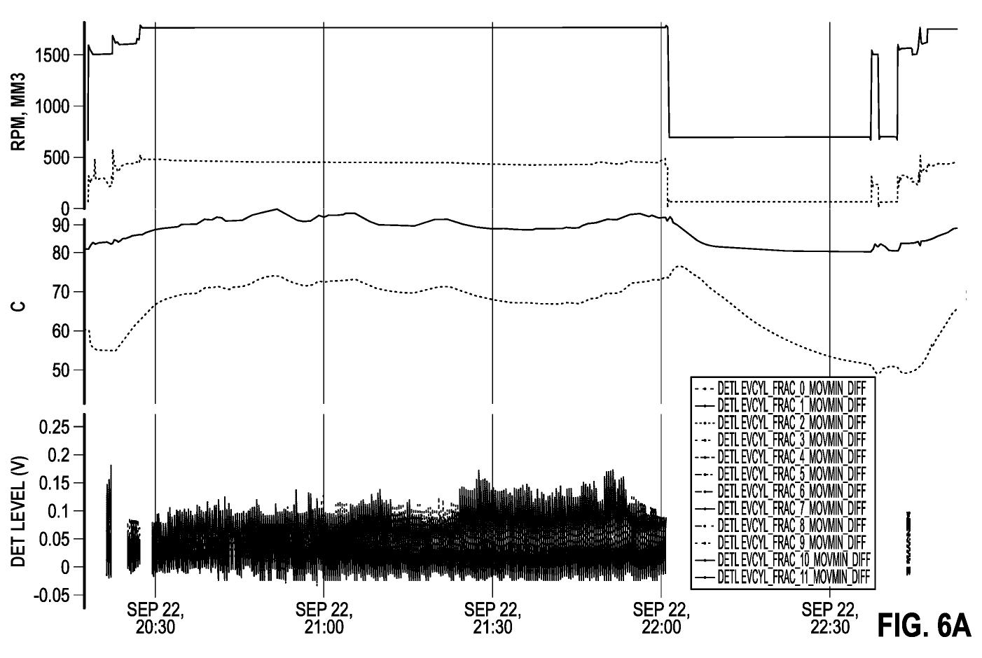

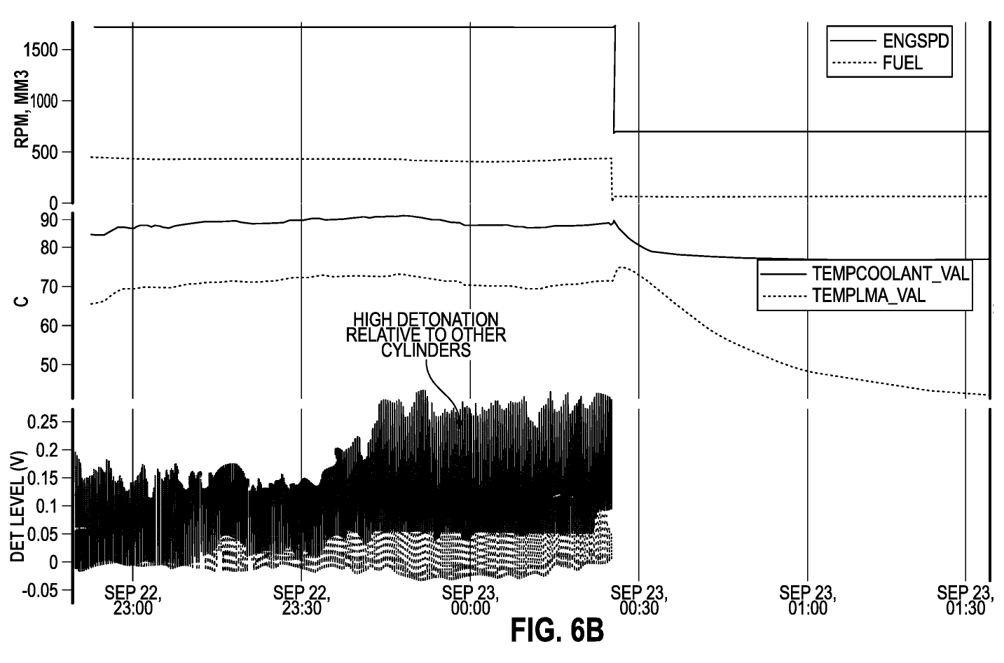

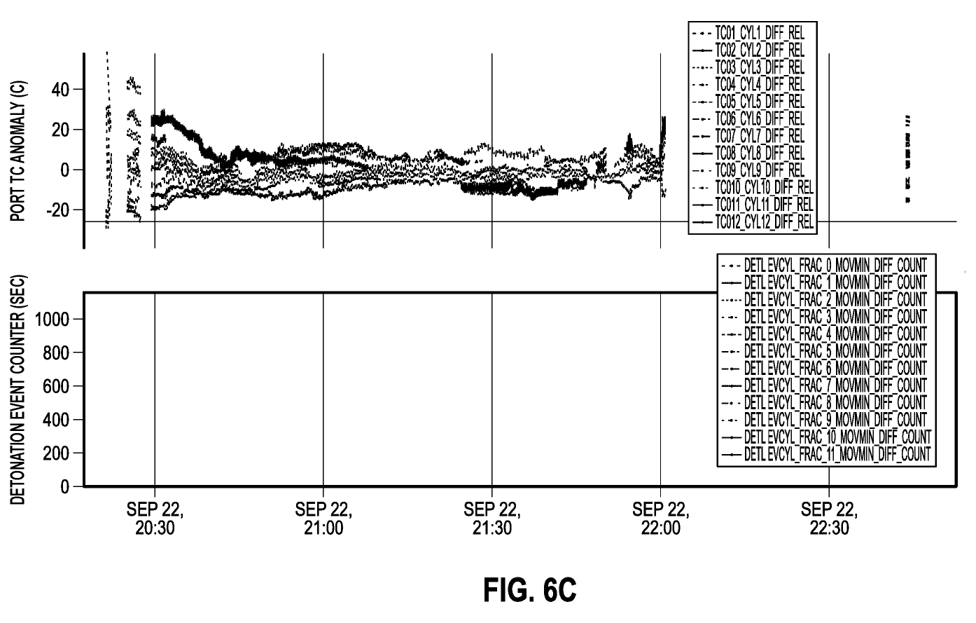

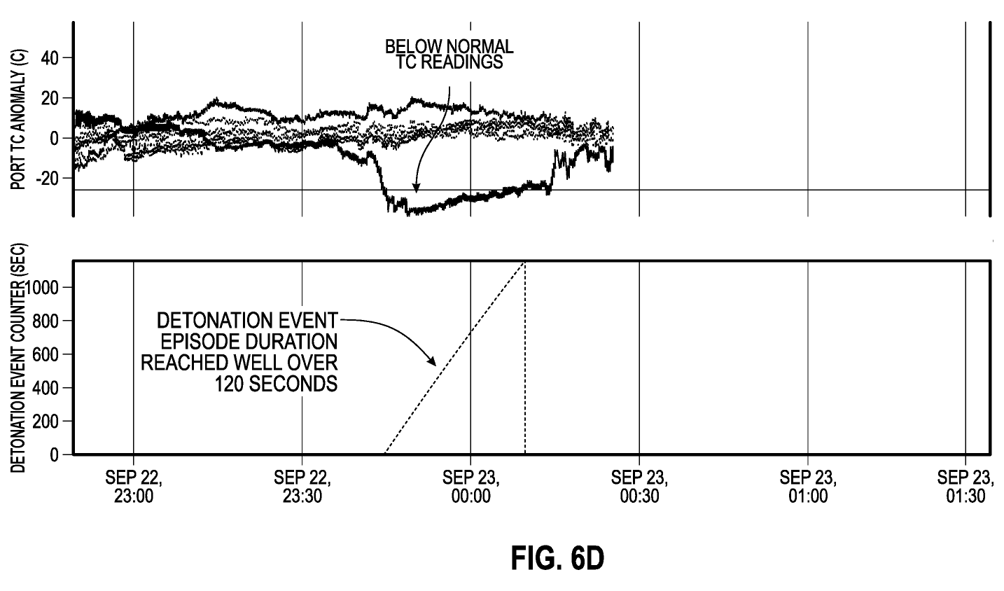

As shown in FIGS. 6A-6D, one example of raw vibration signals and temperature signals is shown. As may be appreciated from a review of the figures, both the vibration level (FIGS. 6A and 6C) and the temperature signal (FIGS. 6B and 6D) of cylinder 12 are varying from the other signals. That is, the vibration level of frac channel 11 (frac channels being numbered 0 to 11 for cylinders 1 to 12, so frac channel 11 reflects cylinder 12) is abnormally high and the temperature level of cylinder 12 is abnormally low. Moreover, both signals are respectively high/low for a period of time well over 120 seconds, which is well beyond the minimum of 5 seconds to constitute an anomaly of interest.

The method may also include sending 210 a notification of an identified detonation event. In one or more examples, the notification may be in the form of an e-mail to the user, operator, or owner of the equipment. In other examples, a text may be sent, an alert may be issued on the equipment, or an alert may be provided in an app on a user, owner, or operator’s mobile device. Still other notifications and mechanism for making the user, owner, and/or operator aware of the condition may be provided.

The method may also include logging 212 the data. For example, having identified the detonation event, the data associated with the detonation event may be stored and logged over time. The data logging may include truncating the data signal for both the exhaust port temperature and the vibration to the relevant time. For example, if the detonation event occurred over a period of 15 seconds, a window of the signal from a few seconds ahead of the 15 second period to a few seconds after the 15 second period may be captured together with operating conditions of the work machine. The values of the exhaust port temperature and the vibration may also be captured and all of this data may be stored in a database as a detonation event. Over time, multiple detonation events including the mentioned pieces of data may be stored. In one or more examples, the logged data may be used for purposes of damage modeling and remaining useful life modeling.

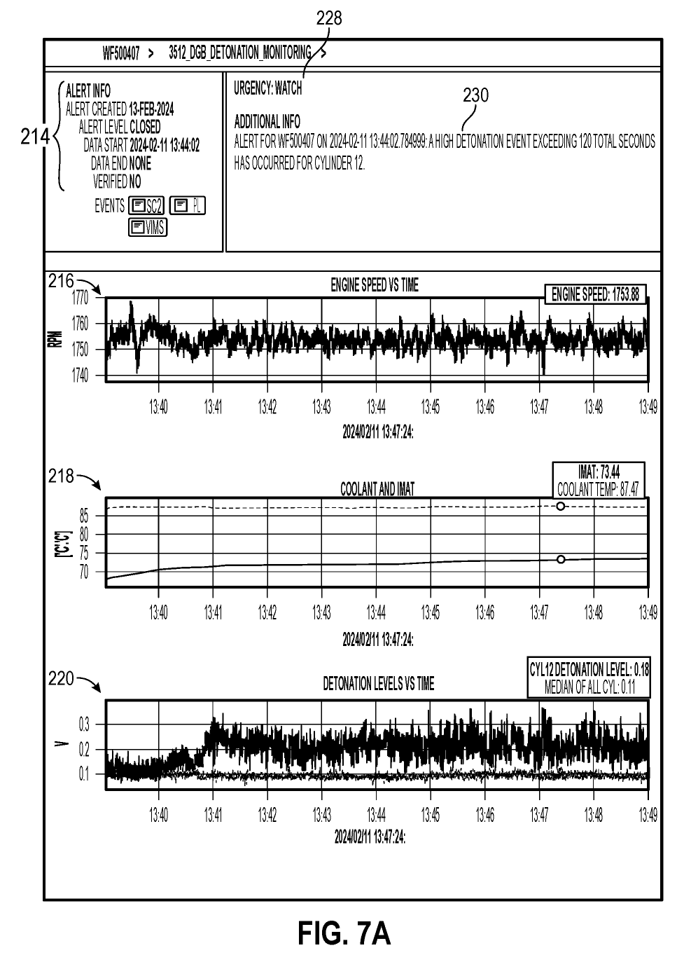

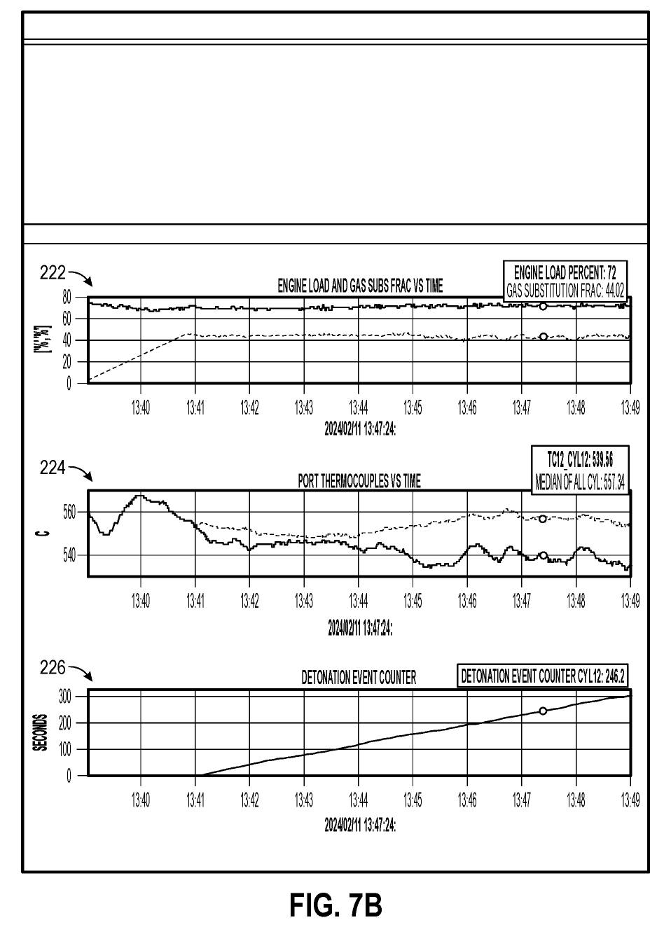

With respect to notifications 210 and/or logging 212, one example of the data included in either or both the notification 210 and logging 212 is shown in FIGS. 7A and 7B. As shown, the notification or data entry may include alert info 214 such as when the alert was created, whether its open or closed, when the data started and when the data ended, as well as whether the data or event was verified. The notification or data entry may also include several signals including the engine speed 216, the coolant and the intake manifold air temperatures 218, the vibration sensor signal or filtered signal 220 for the relevant cylinder, the engine load and natural gas substitution percentage 222, the temperature signal or filtered signal 224 of the relevant cylinder, and the detonation counter 226. As shown, the time frame shown for each of these graphs may be the relevant time just before the detonation event until the event ends or until some point throughout the event sufficient to recognize it as an event (the threshold elapsed time). Still further, the notification and/or data entry may include an urgency level 228 as well as additional information 230 relating to the detonation event such as a statement of the event describing including an equipment reference, a time, and a brief description that it was a detonation event, how long it lasted, and which cylinder it related to.

The method may also include adjusting 232 machine operation to reduce or eliminate ongoing or periodic detonation events. For example, if a detonation event is ongoing, machine operation may be adjusted to stop the detonation event. In addition, if shorter, but nonetheless problematic detonation events continue to occur over a period of time, the machine operation may be adjusted to reduce the number of detonation events or eliminate the detonation events all together. In one or more examples, the adjusting may include reducing the amount of natural gas being delivered to the engine. This may also include increasing the amount of diesel fuel being delivered to the engine. That is, the ratio of natural gas to diesel may be reduced. In some examples, delivery of natural gas may cease all together. In other examples, the adjusting may include adjusting the timing of the fuel delivery. For example, fuel delivery may adjusted to be slightly sooner or slightly later in the engine cycle. In still other examples, the adjusting may include implementing power restrictions on the engine. Still other approaches to adjusting engine operation to reduce or eliminate detonation events may also be provided.

The above detailed description is intended to be illustrative, and not restrictive. The scope of the disclosure should, therefore, be determined with references to the appended claims, along with the full scope of equivalents to which such claims are entitled.

What is claimed is:

1. A system for identifying detonation within one or more of a plurality of cylinders in an engine, the system comprising:
a plurality of vibration sensors arranged on an engine block of the engine and configured to generate vibration signals associated with each of the plurality of cylinders;
a plurality of temperature sensors each arranged at respective exhaust ports of the plurality of cylinders and configured to generate temperature signals of an exhaust gas temperature associated with each of the plurality of cylinders; and
a computing device in data communication with the plurality of vibration sensors and the plurality of temperature sensors and comprising:
a processor; and
a computer readable storage medium having computer implemented instructions stored thereon and performable by the processor for:
receiving a plurality of vibration signals, each being from one of the plurality of vibration sensors;
receiving a plurality of temperature signals, each being from one of the plurality of temperature sensors;
generating a plurality of filtered vibration signals each corresponding to one of the plurality of vibration signals;
generating a plurality of filtered temperature signals each corresponding to one of the plurality of temperature signals;
periodically or continually comparing each of the filtered vibration signals to a vibration threshold;
periodically or continually comparing each of the filtered temperature signals to a temperature threshold;
if any of the filtered vibration signals associated with one of the plurality of cylinders exceed the vibration threshold and a filtered temperature signal associated with the one of the plurality of cylinders exceeds the temperature threshold, monitoring an elapsed time that both the filtered vibration signal and the filtered temperature signal exceed their respective thresholds; and
if the elapsed time exceeds a threshold anomaly time, identifying a detonation event.

2. The system of claim 1, wherein the filtered vibration signals exceed the vibration threshold when a voltage amplitude of the signal is higher than the vibration threshold voltage amplitude.

3. The system of claim 1, wherein the filtered temperature signals exceed the temperature threshold when a temperature value of the signal is lower than the temperature threshold.

4. The system of claim 1, wherein generating a plurality of filtered vibration signals comprises determining a moving minimum for each vibration signal.

5. The system of claim 4, wherein the moving minimum is a 0.5 second moving minimum.

6. The system of claim 4, wherein generating a plurality of filtered vibration signals further comprises calculating a median vibration signal.

7. The system of claim 6, wherein generating a plurality of filtered vibration signals further comprises calculating a difference between the moving minimum and the median.

8. The system of claim 7, wherein comparing each of the filtered vibration signals to a vibration threshold comprises comparing the difference between the moving minimum and the median to a constant vibration threshold.

9. The system of claim 1, wherein generating a plurality of filtered temperature signals comprises subtracting a median signal from the plurality of temperature signals to establish a first filtered temperature signal.

10. The system of claim 9, wherein generating a plurality of filtered temperature signals comprises calculating a difference between the first filtered temperature signal and an exponentially weighted moving average (EWMA).

11. The system of claim 10, wherein the EWMA uses a 60 minute window size.

12. The system of claim 10, wherein generating a plurality of filtered temperature signals comprises comparing the difference between the first filtered temperature signal and the EWMA to a constant temperature threshold.

13. The system of claim 1, wherein the computer implemented instructions performable by the processor are also for adjusting the engine operation to address the detonation event.

14. The system of claim 13, wherein adjusting the engine operation comprises reducing a ratio of natural gas to diesel fuel being delivered to the engine.

15. A method of identifying detonation of an engine having a plurality of cylinders, comprising:
receiving a plurality of vibration signals each associated with one of the plurality of cylinders;
receiving a plurality of temperature signals each associated with one of plurality of cylinders;
generating a plurality of filtered vibration signals each corresponding to one of the plurality of vibration signals;
generating a plurality of filtered temperature signals each corresponding to one of the plurality of temperature signals;
periodically or continually comparing each of the filtered vibration signals to a vibration threshold;
periodically or continually comparing each of the filtered temperature signals to a temperature threshold;
if any of the filtered vibration signals associated with one of the plurality of cylinders exceed the vibration threshold and a filtered temperature signal associated with the one of the plurality of cylinders exceeds the temperature threshold, monitoring an elapsed time that both the filtered vibration signal and the filtered temperature signal exceed their respective thresholds; and
if the elapsed time exceeds a threshold anomaly time, identifying a detonation event.

16. The method of claim 15, wherein the filtered vibration signals exceed the vibration threshold when a voltage amplitude of the signal is higher than the vibration threshold voltage amplitude.

17. The method of claim 15, wherein the filtered temperature signals exceed the temperature threshold when a temperature value of the signal is lower than the temperature threshold.

18. A system for identifying detonation within a cylinder of an engine, the system comprising:
a vibration sensor arranged on an engine block of the engine and configured to generate a vibration signal associated with the cylinder;
a temperature sensor arranged at an exhaust port of the cylinder and configured to generate a temperature signal of the exhaust gas temperature associated with the cylinder; and
a computing device in data communication with the vibration sensor and the temperature sensor and comprising:
a processor; and
a computer readable storage medium having computer implemented instructions stored thereon and performable by the processor for:
receiving the vibration signal;
receiving the temperature signal;
periodically or continually comparing the vibration signal to a vibration threshold;
periodically or continually comparing the temperature signal to a temperature threshold;
if vibration signal exceed the vibration threshold and the temperature signal exceeds the temperature threshold, monitoring an elapsed time that both the vibration signal and the temperature signal exceed their respective thresholds; and
if the elapsed time exceeds a threshold anomaly time, identifying a detonation event.

19. The system of claim 18, wherein the vibration signal exceeds the vibration threshold when a voltage amplitude of the signal is higher than the vibration threshold voltage amplitude.

20. The system of claim 18, wherein the temperature signal exceeds the temperature threshold when a temperature value of the signal is lower than the temperature threshold.
